(19) United States
(12) Patent Application Publication
(10) Pub. No.: US 2009/0119979 A1
(43) Pub. Date: May 14, 2009

(54) CATALYSTS FOR PRODUCTION OF BIODIESEL FUEL AND GLYCEROL

(75) Inventor: Brian Mullen, Plymouth, MN (US)

Correspondence Address: HEAD, JOHNSON & KACHIGIAN, 228 W 17TH PLACE, TULSA, OK, 74119, US

(73) Assignee: IMPERIAL PETROLEUM, INC., Evansville, IL (US)

(21) Appl. No.: 11/937,271

(22) Filed: Nov. 8, 2007

(51) Int. Cl. C10L 1/18; C01B 21/082; C01B 25/02

(52) U.S. Cl. 44/308; 423/302; 423/352

(57) ABSTRACT

A method of producing biodiesel through the trans-esterification of a triglyceride, comprising mixing a triglyceride, an alcohol, and a catalyst to form a mixture, where said catalyst is non-metal quaternary ammonium hydroxide or non-metal quaternary phosphonium hydroxide, removing volatile components from said mixture, and allowing the remaining mixture to separate into a biodiesel-rich layer and a glycerol-rich layer.

### BACKGROUND OF THE INVENTION

1. Field of the Invention

The present invention generally relates to biodiesel and glycerol production. In particular, it relates to a method of producing biodiesel and glycerol using non-metal containing quaternary ammonium hydroxide and non-metal containing quaternary phosphonium hydroxide catalysts.

2. Prior Art

The field of biodiesel production is currently expanding at a rapid rate due to the interest in biodiesel as an alternative fuel source. Usual biodiesel production uses an alkali or alkaline earth metal hydroxide or alkoxide catalyst, e.g., sodium/potassium hydroxide or sodium/potassium methoxide. However, the use of these catalysts is a problem due to the disadvantage that the catalysts need to be neutralized by acid and removed from the biodiesel and glycerol by subsequent water washing to wash the salts out of the biodiesel product and glycerol by-product. The neutralization and purification steps add cost to the biodiesel process and also make it more difficult to achieve purified glycerol, without the added step of distillation of the glycerol.

The biodiesel process may be run in continuous or batch mode. The process may use various methods known in the art to neutralize triglycerides which have a known content of free fatty acid (FFA) prior to reaction with alcohol. The biodiesel process may use any of the known methods in the art for separation of the biodiesel from the glycerol, such as centrifugation, decanting, distillation, simple settling of the reaction mixture, and other methods commonly known. The biodiesel process may use filter agents, such as diatomaceous earth, silica, activated carbon, celite, clay, and other filter agents known in the art to polish the biodiesel and glycerol subsequent to their formation.

There are several examples of prior art in which biodiesel is made in a heterogeneous reaction mixture. The following are representative patents in the area of biodiesel production by reacting a catalyst, an alcohol, and an oil:

U.S. Pat. No. 5,844,111

US 20020035282

U.S. Pat. No. 7,193,097

U.S. Pat. No. 7,157,401

U.S. Pat. No. 6,878,837

U.S. Pat. No. 6,822,105

U.S. Pat. No. 6,489,496

Another process uses a co-solvent (BiOx process) to make biodiesel. U.S. Pat. No. 6,712,867 is an example in this area. The use of the co-solvent enables a homogeneous reaction, lower reaction temperatures, and quick reaction times. However, the patent emphasizes the importance of anhydrous conditions during the biodiesel reaction. The patent discloses the use of linear and cyclic ether co-solvents for the production of biodiesel, but it makes no mention of any other type of solvent. Ether-containing solvents have the potential to generate dangerous peroxides if they are not stabilized, so there is a need to look at alternative solvents. Also, the patent is focused on using traditional alkali and alkaline earth metal hydroxides and alkoxide catalysts used to make biodiesel, which will need to be neutralized with acid and washed with water to gel rid of metal salt species in the biodiesel and glycerol.

Based on the foregoing, (here is a need for a method of biodiesel production using a catalyst that does not need to be neutralized by an acid and removed from the product by subsequent water washing to wash the salts out of the biodiesel product and glycerol by-product and that is not effected by the presence of water during the biodiesel reaction.

Also, there is a need to use alternative co-solvents for the production of biodiesel. One way to produce a more environmentally-friendly version of tetrahydrofuran (THF) is to use recycled streams of THF-methanol-water mixtures derived from the production of poly(butylenes terepthalate) (PBT). Since the PBT process generates millions of pounds of THF-methanol-water by-products annually, it would be advantageous to be able to use these by-products as a co-solvent reaction mixture for the production of environmentally friendly biodiesel.

Yet another need is to use a co-solvent that lacks the ability to form peroxides. Ketone solvents, like acetone and methyl-ethyl-ketone, as well as ketal solvents like 2,2-dimethoxy propane, would be examples of alternative solvents which may be used for the production of biodiesel.

Yet another need would be to use the ketone or ketal solvent to react with glycerol in a subsequent step after biodiesel production. One may envision the glycerol being transformed into 2,2-Dimethyl-4-hydroxymethyl-1,3-dioxolane (solketal) reaction with acetone or 2,2-dimethoxy propane.

Yet another need is the production of alkali and alkaline earth metal salt-free glycerol from the alcoholysis of triglycerides. The glycerol, which will be salt-free, may be sold in a more pure state to a variety of industries.

### BRIEF SUMMARY OF THE INVENTION

This invention describes the use of quaternary ammonium or quaternary phosphonium catalysts for the production of biodiesel from the transesterification of triglycerides with alcohol, preferably methanol or ethanol. The triglycerides may be derived from oils, such as beef tallow, coconut oil, corn oil, cottonseed oil, lard, olive oil, palm oil, palm kernel oil, peanut oil, soybean oil, linseed oil, tung oil, sunflower oil, safflower oil, canola oil, rapeseed oil, sesame oil, babassu oil, perilla oil, oiticica oil, fish oils, menhaden oil, castor oil, Chinese tallow tree oil, Physic nut oil, Cuphea seed oil, microalgal oils, jatropha oil, bacterial oils and fungal oils. The biodiesel may be derived from the reaction of the oil and a primary or secondary aliphatic alcohol, e.g., methanol, ethanol, butanol, isopropanol, etc. The invention also describes the use of ketone co-solvents, preferably acetone or methyl ethyl ketone to aid in the quarternary ammonium catalyzed reaction of alcohol and oil to form biodiesel.

The quaternary ammonium or phosphonium catalysts are advantageous for a number of reasons:
1. They may be removed from the biodiesel and glycerol products by simple heating and evacuation or by passing through an acidic column. There is no need for neutralization of the catalyst with an acidic solution or washing the products with aqueous solvents to get rid of metal-salt substances.
2. They are highly reactive catalysts for biodiesel and glycerol production (low catalyst levels, quick reaction times, and relatively low reaction temperatures).
3. They may be used with or without the use of a co-solvent system.
4. They are relatively inexpensive and commercially available.

The ketone or ketal co-solvent systems are advantageous for a number of reasons:
1. They do not form dangerous peroxides that may be formed by ether-containing co-solvent systems.
2. They are relatively volatile, so they can be distilled out of the reaction mixture quite easily.
3. They may speed-up the reaction of alcohol and oil by making the reaction mixture homogenous.
4. They may be available to react with glycerol in a subsequent step after biodiesel production to form solketal.

A better understanding of the invention will be obtained from the following detailed description of the preferred embodiment taken in conjunction with the attached claims.

### DETAILED DESCRIPTION OF THE PREFERRED EMBODIMENTS

It is to be understood that the invention that is now to be described is not limited in its application to the details of the construction and arrangement of the parts illustrated in the accompanying drawings. The invention is capable of other embodiments and of being practiced or carried out in a variety of ways. The phraseology and terminology employed herein are for purposes of description and not limitation.

The preferred embodiment of the invention is a method of producing biodiesel using non-metal containing quaternary ammonium hydroxides or non-metal containing quaternary phosphonium hydroxides as catalysts for the transesterification of triglycerides with alcohol. The alcohol may be a primary or secondary aliphatic alcohol, preferably methanol, ethanol, propanol, butanol, or mixtures thereof. The triglycerides may be derived from oils, such as beef tallow, coconut oil, corn oil, cottonseed oil, lard, olive oil, palm oil, palm kernel oil, peanut oil, soybean oil, linseed oil, tung oil, sunflower oil, safflower oil, canola oil, rapeseed oil, sesame oil, babassu oil, perilla oil, oiticica oil, fish oils, menhaden oil, castor oil, Chinese tallow tree oil, Physic nut oil, Cuphea seed oil, microalgal oils, jatropha oil, bacterial oils and fungal oils.

The triglyceride, alcohol, and catalyst are mixed together, using an amount of catalyst sufficient to effect trans-esterification in said mixture to cause visible separation of alkyl ester and triol. The user may stir the mixture, may leave the mixture stagnant for a certain period of time, or may move immediately to the next step. In all instances, the next step is to heat the reaction mixture to effectively remove volatile components from said mixture. This may be accomplished by heating the mixture and distilling the volatile components under reduced pressure or at atmospheric pressure. Once the volatile components have been removed from said mixture, the next step is to allow the mixture to spatially separate into an upper biodiesel-rich layer and a lower glycerol-rich layer. Centrifugation or decanting may also be used to aid in the separation of biodiesel and glycerol.

In an alternative embodiment, Amberlyst A26 anion exchange resin is used as a catalyst, and it is combined into a mixture along with triglyceride and alcohol.

In another embodiment, the catalyst is preferably a tetra-alkyl (C1-C4) substituted ammonium or phosphonium hydroxide compound. The catalyst may also be derived from branched tetra-alkyl substituted ammonium or phosphonium hydroxides. The catalyst may also be derived from tetra-aryl, tetra-arylalkyl, or tetra-alkylaryl substituted ammonium or phosphonium hydroxides. The preferred catalyst may be used in combination with any of the above mentioned catalysts. The preferred catalyst may also be used in combination with traditional alkali or alkaline earth metal hydroxide or alkoxide catalysts.

In another embodiment, the catalyst may be used as a neat solution, solid mass, or it may be pre-dissolved in water, methanol, or co-solvent. In the preferred embodiment, the catalyst is pre-dissolved in water or methanol.

In another embodiment, a mono-ether cosolvent may be added to the mixture containing the alcohol, catalyst, and triglyceride. The ether co-solvent is preferably THF or methyl-tertiarybutyl ether, and it is preferably stabilized against forming peroxides. The ether co-solvent is preferably removed from the reaction mixture as a volatile component and may be co-distilled with the alcohol and separated in a subsequent step or not separated.

In another embodiment, the THF co-solvent system may contain methanol and water. This mixture is preferentially derived from the volatile by-products of the poly(butylene terepthalate) polymerization process. The preferred co-solvent system may contain >1% water by weight. The co-solvent system may also contain >1% methanol by weight, preferably above 2% methanol by weight, and most preferably above 3% methanol by weight.

In another embodiment, a ketone co-solvent is used instead of a mono-ether containing solvent. In a preferred embodiment, the ketone solvent is acetone or methyl ethyl ketone; most preferably the ketone solvent is acetone.

In another embodiment, the solvent may be a ketal co-solvent, for instance 2,2-dimethoxy propane, 2,2-dimethoxy-butane, or 2,2-diethoxy propane. Preferably, the co-solvent is 2.2-dimethoxy propane.

In another embodiment, the ketone solvent or the ketal co-solvent is reacted with glycerol subsequent to biodiesel formation and glycerol separation. The ketone co-solvent, acetone, will react with glycerol under acidic conditions to form solketal and water. The ketal co-solvent, 2,2-dimethoxy propane, will react with glycerol under acidic conditions to form solketal and methanol. The acid catalyst may be a homogeneous, heterogeneous or a mixed catalyst system.

The following examples were performed in the laboratory:

### EXAMPLE 1

Into a 3-necked round-bottom flask, equipped with a magnetic stirrer, was charged 50.1 g of canola oil, 49.0 g of tetrahydrofuran (THF), 47.5 g of anhydrous methanol, and 4.2 g of tetramethylammonium hydroxide (TMAH, 25 wt % solution in methanol). Upon catalyst addition, the clear solution became cloudy. After 1 minute of stirring, the solution became clear and slightly more yellow than the initial color before TMAH addition. The mixture was stirred at room temperature for a total of 10 min. Then, the solution was transferred into a one-necked round bottom flask, placed on a rotary evaporator, and the products were concentrated in vacuo (heating bath temperature=70-80° C.). After complete evaporation of the volatile components, the mixture was allowed to spatially separate. The upper layer (biodiesel-rich layer) weighed 50.1 g. The lower layer (glycerol-rich layer) was clear, slightly discolored, and free of metal-containing salts.

### EXAMPLE 2

Into a 3-necked round-bottom flask, equipped with a magnetic stirrer, was charged 50.1 g of canola oil, 22 g of anhydrous methanol, 4.3 g of TMAH (25 wt % solution in methanol), and 78.3 g of a solution containing 60% THF: 30% methanol: 10% deionized water. Initially, the mixture was yellow and cloudy. After the 10 min reaction at room temeperature, the mixture was less yellow and cloudy than the initial observation. Then, the solution was transferred into a one-necked round bottom flask, placed on a rotary evaporator, and the products were concentrated in vacuo (heating bath temperature=70-80° C.). During the purification work-up, some of the products had bubbled overhead resulting in product yield loss. After complete evaporation of the volatile components, the mixture was allowed to spatially separate. The upper layer (biodiesel-rich layer) weighed 43 g. The lower layer (glycerol-rich) was clear, slightly discolored, and free of metal-containing salts.

### EXAMPLE 3

Into a single-necked round-bottom flask was charged 16.5 g of canola oil. 16.3 g of THF, 15.8 g of anhydrous methanol, and 0.2 g of TMAH (25 wt % solution in methanol). The flask was immediately placed on a rotary evaporator, and the products were concentrated in vacuo by a water aspirator (heating bath temperature=70-80° C.). After complete evaporation of the volatile components, the mixture was allowed to spatially separate. The upper layer (biodiesel-rich layer) weighed 16.65 g. The lower layer (glycerol-rich layer) was clear, slightly discolored, and free of metal-containing salts.

### EXAMPLE 4

Into a single-necked round-bottom flask was charged 17.4 g of canola oil, 18.3 g of THF, 15.8 g of anhydrous methanol, and 0.04 g of TMAH (25 wt % solution in methanol). The flask was immediately placed on a rotary evaporator, and the products were concentrated in vacuo by a water aspirator (heating bath temperature=70-80° C.). After complete evaporation of the volatile components, the mixture was allowed to spatially separate. The upper layer (biodiesel-rich layer) weighed 17.8 g. The lower layer (glycerol-rich layer) was clear, slightly discolored, and free of metal-containing salts.

### EXAMPLE 5

Into a single-necked round-bottom flask was charged 17.8 g of canola oil, 16.0 g of THF, 14.4 g of anhydrous methanol, and 0.05 g of TMAH (25 wt % solution in methanol). The flask was immediately placed on a rotary evaporator, and the products were concentrated in vacuo by a water aspirator (heating bath temperature=70-80° C.). After complete evaporation of the volatile components, the mixture was allowed to spatially separate. The upper layer (biodiesel-rich layer) weighed 18.0 g. The lower layer (glycerol-rich layer) was clear, slightly discolored, and free of metal-containing salts.

### EXAMPLE 6

Into a 3-necked round-bottom flask, equipped with a magnetic stirrer, was charged 50.1 g of canola oil. The oil was stirred and heated to 55-60° C. by use of a heating mantle. Then, 11.5 g of anhydrous methanol and 0.05 g of TMAH (25 wt % solution in methanol) was added to the flask. The reaction was stirred for 60 min at 55-60° C. Then, the solution was transferred into a one-necked round bottom flask, placed on a rotary evaporator, and the products were concentrated in vacuo (heating bath temperature=70-80° C.). After complete evaporation of the volatile components, the mixture was allowed to spatially separate. The upper layer (biodiesel-rich layer) weighed 50.0 g. The lower layer (glycerol-rich layer) was clear, slightly discolored, and free of metal-containing salts.

### EXAMPLE 7

Into a 3-necked round-bottom flask, equipped with a magnetic stirrer, was charged 17.4 g of canola oil. 16.8 g of THF, 16.5 g of anhydrous methanol, and 1.0 g of an anion exchange resin, Amberlyst A26. The contents were stirred at room temperature for 10 min. Then, the Amberlyst A26 resin was filtered and discarded. Then, the solution was transferred into a one-necked round bottom flask, placed on a rotary evaporator, and the products were concentrated in vacuo (healing bath temperature=70-80° C.). After complete evaporation of the volatile components, the mixture was allowed to spatially separate. The upper layer (biodiesel-rich layer) weighed 12.8 g. The lower layer (glycerol-rich layer) was clear, slightly discolored, and free of metal-containing salts.

### EXAMPLE 8

Into a 3-necked round-bottom flask, equipped with a magnetic stirrer, was charged 17.3 g of canola oil, 15.9 g of THF, 15.4 g of anhydrous methanol, and 1.0 g of an anion exchange resin, Amberlyst A26. The contents were stirred at room temperature for 10 min. Then, the Amberlyst A26 resin was filtered and discarded. Then, the solution was transferred into a one-necked round bottom flask, placed on a rotary evaporator, and the products were concentrated in vacuo (healing bath temperature=70-80° C.). After complete evaporation of the volatile components, the mixture was allowed to spatially separate. The upper layer (biodiesel-rich layer) weighed 15.3 g. The lower layer (glycerol-rich layer) was clear, slightly discolored, and free of metal-containing salts.

### EXAMPLE 9

Into a single-necked round-bottom flask was charged 16.9 g of canola oil, 17.6 g of acetone, 16.7 g of anhydrous methanol, and 0.08 g of TMAH (25 wt % solution in H₂O). The contents in the flask were in 2 separate phases. The flask was immediately placed on a rotary evaporator, and the products were concentrated in vacuo by a water aspirator (healing bath temperature=70-80° C.). After complete evaporation of the volatile components, the mixture was allowed to spatially separate. The upper layer (biodiesel-rich layer) weighed 16.6 g. The lower layer (glycerol-rich layer) was clear, slightly discolored, and free of metal-containing salts.

### EXAMPLE 10

Into a single-necked round-bottom flask was charged 33.4 g of canola oil, 31.8 g of acetone, 33.5 g of anhydrous methanol, and 0.08 g of TMAH (25 wt % solution in H₂O). The contents in the flask were clear and yellowish. The contents in the flask were stirred for 10 minutes. Then, the contents of the flask were split evenly into 2 separate flasks (Ex. 10a and Ex. 10b).

### Ex. 10a

(weight of contents=48.2 g) was immediately placed on a rotary evaporator, and the products were concentrated in vacuo by a water aspirator (heating bath temperature=70-80° C.). After complete evaporation of the volatile components, the mixture was quickly formed two spatially separated layers. The upper layer (biodiesel-rich layer) weighed 16.6 g. The lower layer (glycerol-rich layer) was clear, slightly discolored, and free of metal-containing salts.

### Ex. 10b

(weight of contents=49.03 g) was stirred with Amberlyst® A15 acidic ion-exchange resin for 5 minutes at room temperature. The ion-exchange resin was filtered by vacuum filtration, and the filtrate was concentrated in vacuo by rotary evaporation (healing bath temperature=70-80° C.). After complete evaporation of the volatile components, the mixture did not separate. Thus, the reaction did not produce biodiesel and glycerol in sufficient yield to afford separation.

### COMPARATIVE EXAMPLE 1

Into a 3-necked round-bottom flask, equipped with a magnetic stirrer, was charged 50.5 g of canola oil, 48.7 g of THF, 50.8 g of anhydrous methanol, and 0.8 g of magnesium oxide. The contents were stirred at room temperature for 10 min. Then, the magnesium oxide was filtered and discarded. Then, the solution was transferred into a one-necked round bottom flask, placed on a rotary evaporator, and the products were concentrated in vacuo (heating bath temperature=70-80° C.). After complete evaporation of the volatile components, the mixture did not separate. Thus, the reaction did not produce biodiesel and glycerol in sufficient yield to afford separation.

### COMPARATIVE EXAMPLE 2

Into a 3-necked round-bottom flask, equipped with a magnetic stirrer, was charged 50.2 g of canola oil, 47.1 g of THF, 51.0 g of anhydrous methanol, and 0.8 g of alumina silicate. The contents were stirred at room temperature for 10 min. Then, the alumina silicate was filtered and discarded. Then, the solution was transferred into a one-necked round bottom flask, placed on a rotary evaporator, and the products were concentrated in vacuo (heating bath temperature=70-80° C.). After complete evaporation of the volatile components, the mixture did not separate. Thus, the reaction did not produce biodiesel and glycerol in sufficient yield to afford separation.

### COMPARATIVE EXAMPLE 3

Into a 3-necked round-bottom flask, equipped with a magnetic stirrer, was charged 49.8 g of canola oil, 48.0 g of THF, 51.0 g of anhydrous methanol, and 0.8 g of titanium isoproxide. The contents were stirred at room temperature for 10 min. Then, the solution was transferred into a one-necked round bottom flask, placed on a rotary evaporator, and the products were concentrated in vacuo (heating bath temperature=70-80° C.). After complete evaporation of the volatile components, the mixture did not separate. Thus, the reaction did not produce biodiesel and glycerol in sufficient yield to afford separation.

### COMPARATIVE EXAMPLE 4

Into a 3-necked round-bottom flask, equipped with a magnetic stirrer, was charged 17.7 g of canola oil, 17.0 g of THF, 16.8 g of anhydrous methanol, and 1.0 g of Amberlite IRA-400. The contents were stirred at room temperature for 10 min. Then, the Amberlite IRA-400 resin was filtered and discarded. The filtered solution was transferred into a one-necked round bottom flask, placed on a rotary evaporator, and the products were concentrated in vacuo (heating bath temperature=70-80° C.). After complete evaporation of the volatile components, the mixture did not separate. Thus, the reaction did not produce biodiesel and glycerol in sufficient yield to afford separation.

### COMPARATIVE EXAMPLE 5

Into a 3-necked round-bottom flask, equipped with a magnetic stirrer, was charged 19.2 g of canola oil, 16.7 g of triethylamine (TEA), 16.5 g of anhydrous methanol, and 0.04 g of (25 wt % solution in H₂O). The clear, yellowish solution was transferred into a one-necked round bottom flask, placed on a rotary evaporator, and the products were concentrated in vacuo (heating bath temperature=70-80° C.). After complete evaporation of the volatile components, the mixture did not separate. Thus, the reaction did not produce biodiesel and glycerol in sufficient yield to afford separation.

TABLE 1
Summary of reaction conditions for the production of biodiesel.

| | Pre- | | | | Biodiesel/Glycerol | | |
|---|---|---|---|---|---|---|---|
| | Reaction | Pre-Reaction | | Catalyst | Separation | | % Water in |
| Entry | Time² | Temperature | Catalyst | Concentration⁵ | (Y/N)⁶ | Cosolvent | Reaction⁷ |
| Ex. 1 | 10 min | 23 C. | TMAH³ | 8.9% | Y | THF | 0 |
| Ex. 2 | 10 min | 23 C. | TMAH³ | 8.6% | Y | THF | 7.8 |
| Ex. 3 | 0 min | — | TMAH³ | 1.2% | Y | THF | 0 |
| Ex. 4 | 0 min | — | TMAH³ | 0.2% | Y | THF | 0 |
| Ex. 5 | 0 min | — | TMAH³ | 0.3% | Y | THF | 0 |
| Ex. 6 | 60 min | 55-60 C. | TMAH³ | 0.1% | Y | none | 0 |
| Ex. 7 | 10 min | 23 C. | Amberlyst | 5.7% | Y | THF | 0 |
| | | | A26 | | | | |
| Ex. 8 | 10 min | 23 C. | Amberlyst | 5.7% | Y | THF | 0 |
| | | | A26 | | | | |
| Ex. 9 | 0 min | — | TMAH⁴ | 0.5% | Y | acetone | 0 |
| Ex. | 10 min | 23 C. | TMAH⁴ | 0.2% | Y | acetone | 0 |
| 10a | | | | | | | |
| Ex. | 10 min | 23 C. | TMAH⁴ | 0.2% | N | acetone | 0 |
| 10b | | | | | | | |
| CEx. 1 | 10 mn | 23 C. | MgO | 1.6% | N | THF | 0 |
| CEx. 2 | 10 min | 23 C. | Al Silicate | 1.6% | N | THF | 0 |
| CEx. 3 | 10 min | 23 C. | Ti(OiPr)₄ | 1.6% | N | THF | 0 |
| CEx. 4 | 10 min | 23 C. | Amberlite | 5.7% | N | THF | 0 |
| | | | IRA-400 | | | | |
| CEx. 5 | 0 min | — | TMAH | 0.20% | N | TEA | 0 |

¹Ex 10b was stirred with Amberlyst A15 prior to rotary evaporation of volatile components.
²Reaction stir time prior to rotary evaporation of volatile components.
³25 wt % TMAH solution in methanol.
⁴25 wt % TMAH solution in water.
⁵Catalyst concentration = wt. of catalyst or catalyst solution/wt. of canola oil
⁶Separated into visibly separated layers in the absence of volatile components (upper biodiesel-rich layer and lower glycerol-rich layer).
⁷% Water intentionally added to the reaction not derived from the catalyst solution

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

What is claimed is:

1. A process of producing biodiesel fuel through trans-esterification of a triglyceride, comprising:
(1) mixing a triglyceride, an alcohol, and a catalyst to form a mixture, where said catalyst comprises non-metal containing quaternary ammonium hydroxide or non-metal containing quaternary phosphonium hydroxide;
(2) removing volatile components from said mixture;
(3) allowing the remaining mixture to separate into a biodiesel-rich layer and a glycerol-rich layer; and
(4) recovering biodiesel produced.

2. The process of claim 1 as set forth in claim 1 including the additional step of recovering glycerol produced free of metal containing salts.

3. The process of claim 1 where said triglyceride is selected from the group consisting of beef tallow, coconut oil, corn oil, cottonseed oil, lard, olive oil, palm oil, palm kernel oil, peanut oil, soybean oil, linseed oil, tung oil, sunflower oil, safflower oil, canola oil, rapeseed oil, sesame oil, babassu oil, perilla oil, oiticica oil, fish oils, menhaden oil, castor oil, Chinese tallow tree oil, Physic nut oil, Cuphea seed oil, microalgal oils, jatropha oil, bacterial oils and fungal oils.

4. The process of claim 1 where said alcohol is primary or secondary aliphatic alcohol.

5. The process of claim 1 where said alcohol is selected from a group consisting of methanol, ethanol, propanol, butanol, and mixtures thereof.

6. The process of claim 1 where the amount of catalyst used is an amount sufficient to effect trans-esterification in said mixture to cause visible separation of alkyl ester and triol.

7. The process of claim 6 where the catalyst further comprises an anion exchange resin containing quaternary ammonium hydroxide functionality.

8. The process of claim 1 where the removal of volatile components from said mixture is accomplished via continuous distillation.

9. The process of claim 11 where the evaporation is accomplished by distillation of the volatile components under reduced pressure.

10. The process of claim 1 further comprising adding a co-solvent during step (1).

11. The process of claim 13 where said co-solvent is a mono-ether co-solvent.

12. The process of claim 13 where said co-solvent is a THF-methanol-water co-solvent mixture.

13. The process of claim 15 where said THF-methanol-water co-solvent mixture is derived from the production of poly(butylene terepthalate).

14. The process of claim 13 where said co-solvent is a ketone co-solvent.

15. The process of claim 13 where said co-solvent is a ketal co-solvent.

16. The process of claim 17 further comprising reacting said ketone co-solvent with glycerol using an acid catalyst.

17. The process of claim 18 further comprising reacting said ketal co-solvent with glycerol using an acid catalyst.

18. A catalyst that produces biodiesel fuel and glycerol, substantially free of metal-containing salts, through trans-esterification when said catalyst is combined with a triglyceride and an alcohol, volatile compounds are removed from said combination, and the remaining mixture is allowed to separate into a biodiesel-rich layer and a glycerol-rich layer, wherein said catalyst comprises:
non-metal containing quaternary ammonium hydroxide or
non-metal containing quaternary phosphonium hydroxide.
